(19) United States
(12) Patent Application Publication
(10) Pub. No.: US 2020/0262291 A1
(43) Pub. Date: Aug. 20, 2020

(54) MOTOR-VEHICLE LIQUID TANK HAVING AN INTEGRATED FLOAT VALVE

(71) Applicant: Röchling Automotive SE & Co. KG, Mannheim (DE)

(72) Inventors: Enrico Collatuzzo, Leifers (IT); Filippo Dall'Armellina, Bolzano (IT)

(21) Appl. No.: 16/794,555

(22) Filed: Feb. 19, 2020

(30) Foreign Application Priority Data
Feb. 20, 2019 (DE) 10 2019 104 333.6

(51) Int. Cl. B60K 15/03; B60K 13/04

(52) U.S. Cl. CPC B60K 15/03; B60K 2015/03289; B60K 13/04

(57) ABSTRACT

A liquid tank, in particular for a motor vehicle, encompassing: a tank shell surrounding an internal tank volume; and at least one tank opening for filling the tank as intended with a liquid that is to be stored and/or for removing stored liquid as intended from the tank, the tank further including a float valve that, depending on its operating position, opens or closes for a flow of fluid a valve opening that passes through the tank shell and is different from the at least one tank opening, the tank further including a valve housing, which guides a float valve in its motion between its closed position in which it closes off the valve opening and its open position in which it enables a flow of fluid through the valve opening, is embodied in one piece with the tank shell.

This application claims priority in German Patent Application DE 10 2019 104 333.6 filed on Feb. 20, 2019, which is incorporated by reference herein.

The present invention relates to a liquid tank encompassing: a tank shell surrounding an internal tank volume; and at least one tank opening for filling the tank as intended with a liquid that is to be stored and/or for removing stored liquid as intended from the tank, the tank further comprising a float valve that, depending on its operating position, opens for a flow of fluid a valve opening that passes through the tank shell and is different from the at least one tank opening, or closes it. This liquid tank is preferably suitable for and embodied as a liquid tank for a motor vehicle.

### BACKGROUND OF THE INVENTION

A liquid tank of this kind, hereinafter also referred to simply as a “tank,” is known from DE 100 17 323 A1. The known tank comprises a tank shell and a float valve inserted into the tank lid of the tank shell and embodied separately from the tank shell. When the fill level of the tank has fallen below a predetermined value, the float valve permits a flow through the valve opening so that a gas exchange can take place between the internal tank volume and the external environment of the tank. When the valve opening is flowthrough-capable, the pressure of the gas component in the tank is thus always atmospheric or ambient pressure. When a fill level of the tank has reached a predetermined fill level, however, a float valve body is brought into abutment against a valve seat by the liquid stored in the tank, so that a flow of liquid through the valve opening is blocked. Such float valves serve to furnish a residual gas space having a predetermined minimum volume of gas in the tank, so that expansions in volume of the incompressible liquid in the tank, caused by expected increases in temperature, can also take place without thereby damaging the tank shell or a functional portion of the tank, for example a closure.

Thanks to the pressure increase that they cause, float valves of this kind on tanks make a significant contribution to automatic shutoff of a nozzle in order to reliably prevent overfilling of the tank.

A disadvantage of the liquid tank known from DE 100 17 323 A1 is the considerable installation outlay associated with attachment of the float valve, or more precisely of the valve housing of the float valve, onto the tank shell. In addition, installation of the float valve on the tank shell furthermore requires provision, in the tank shell, of a recess that as a rule is considerably larger than the valve opening of the float valve, with the result that the tank shell can be structurally weakened to an unnecessary extent by the separate float valve attached to it.

### SUMMARY OF THE INVENTION

An object of the present invention is therefore to refine the tank recited initially in such a way that the aforementioned functionality of the float valve, namely fill-level-dependent closure of the otherwise open valve opening upon exceedance of a predetermined fill level, is achieved with less installation outlay and, if possible, simultaneously with greater structural integrity of the tank shell.

This object is achieved according to the present invention, in a tank of the kind recited initially, by the fact that a valve housing, which guides a float valve in its motion between its closed position in which it closes off the valve opening and its open position in which it enables a flow of fluid through the valve opening, is embodied in one piece with the tank shell.

Thanks to the one-piece embodiment of the valve housing with the tank shell, installation of the valve housing on the tank shell becomes superfluous, since the valve housing is already produced together with the tank shell upon manufacture thereof.

In addition, with the one-piece embodiment of the valve housing on the tank shell, only the valve opening needs to be embodied on the tank shell as an opening passing through the tank shell. A larger installation opening, into which a separately constituted valve housing is inserted, is no longer needed. The structural weakening of the tank shell necessary for placement of the float valve is thereby minimized. On the contrary, the valve housing embodied in one piece with the tank shell can in fact, like ribs, have a stiffening effect on the tank shell portion that carries the valve housing.

The valve housing is preferably manufactured, together with the tank shell, by injection molding from a viscous moldable compound. The tank shell is preferably manufactured, along with the float valve embodied in one piece with it, from thermoplastic material.

The valve housing can comprise a passage through its housing wall in order to enable an exchange of fluid in the internal tank volume between a valve housing internal space and an external environment of the valve housing.

In order to facilitate installation, the float valve is made up of only two sub-elements, namely the valve housing and the float valve body. The valve housing is preferably embodied in one piece and is made up only of the component manufactured in one piece with the tank shell. It is conceivable in principle for the valve housing to be at least partly closed off, after introduction of the float valve into the valve housing, with a separate cover at its longitudinal end remote from the tank shell, but this is not preferred.

The float valve body can also be embodied in one piece and can thus be made up of a single component. Alternatively, the float valve body can also be embodied in multiple parts, for example if it comprises, in addition to a buoyancy body, a valve seal that is separately constituted and is arranged on a buoyancy body. In addition or alternatively to a valve seal on the buoyancy body, a seal component can also be provided in the valve housing, for example surrounding the valve opening and thus forming a valve seat. This seal component can have been attached to the valve opening subsequently, i.e. after manufacture of the valve housing, or can be generated, essentially simultaneously with the valve housing, by injection molding in a two-component injection-molding process. In order to furnish an optimum sealing function even at a low abutment pressure, the seal component is then preferably constituted from a plastic having a lower modulus of elasticity, compared with the valve housing and thus compared with the tank shell, than the remainder of the valve housing.

In order to simplify the configuration of the tank shell together with the valve housing, provision can be made that the tank shell comprises a one-piece lower tank shell comprising a tank bottom and a lower (during operation of the tank as intended) portion of tank side walls, and a one-piece upper tank shell comprising a tank lid and an upper (during tank operation as intended) portion of tank side walls. The valve housing is then constituted in one piece with the upper tank shell. Because the tank shell is configured in at least two sub-shells, the valve housing can be shaped onto a tank sub-shell, in particular on the upper tank shell, in simple fashion and without complex cores or sliders. Particularly preferably, the valve housing is configured in one piece with the tank lid that is located at a distance oppositely from the tank bottom. The two or several tank shells preferably comprise connecting flanges at which two respective tank shells, which are adjacent on the complete, operationally ready tank, are connectable or connected to one another. This connection of adjacent tank shells on the tank can be a connection intended to be detachable, for example a bolted connection; or it can be a connection intended to be nondetachable, for example a welded or adhesively bonded connection.

It is conceivable in principle for a respective sub-portion of the valve housing to be present both on the inner side and on the outer side of the tank shell. This is not necessary, however, for the mere purpose of furnishing the functionality of the float valve, i.e. opening and closing the valve opening, and can unnecessarily complicate the manufacture of the tank shell or of a tank sub-shell. Provision is therefore preferably made that the valve housing projects protrudingly from a tank shell portion into the internal tank volume. Particularly preferably, provision is made that the valve housing projects protrudingly from a tank shell portion only into the internal tank volume.

In order to allow fluid flowing through the valve opening to be delivered or at least directed in controlled fashion after passing through the tank shell, according to a preferred refinement of the present invention the tank shell comprises on its side facing away from the valve housing, which is preferably its outer side of the tank, an attachment configuration for attachment of a fluid conduit. This attachment configuration, for example a sleeve-shaped attachment or fitting projecting away from the tank shell, is also preferably constituted in one piece with the tank shell.

In order to facilitate incorporation of the float valve body into the valve housing, it is preferred that the valve housing be configured tubularly. Particularly preferably, it is configured only tubularly. It is immaterial in this context whether the valve housing has a circularly cylindrical shape, a polyhedral or elliptically cylindrical shape, or a shape that is slightly conical as a result of draft angles. In order to facilitate unmolding of the tank shell, embodied in one piece with the valve housing, from an injection mold, the opening cross section of the valve housing preferably widens slightly with increasing distance from the tank shell. For easier removal, the valve housing wall can taper away from the tank shell, and it preferably forms a draft angle both on its outer side and on its inner side.

It is also conceivable in principle for the float valve body, when it is not protruding into liquid stored in the tank, to protrude out of the valve housing with its end portion remote from the valve opening. This makes possible a physically short configuration of a valve housing. In order to avoid unnecessary and undesired jamming of the float valve body, however, and thus undesired immobilization of the float valve body on the valve housing, it is preferred if the valve housing surrounds the float valve body, regardless of the latter's operating position, along its entire length of extent in the direction of its motion path.

When the valve housing extends in tubular fashion away from the tank shell, preferably only into the internal tank volume, the valve housing extends along a virtual tube axis that, in order to simplify the description, is to be considered to pass centrally through the valve housing. When the valve housing is a cylinder, the virtual tube axis is the cylinder axis. When the valve housing is a cone, the virtual tube axis is the cone axis. In the case of a tubularly embodied valve housing, the motion path of the float valve body preferably proceeds along the tube axis.

For maximally exact motion guidance of the float valve body between an operating position of maximum proximity to the valve opening, in which the float valve body blocks a flow of fluid through the valve opening, and an operating position of maximum distance from the valve opening, in which fluid can flow through the valve opening, the tubular valve housing extending along the virtual tube axis can comprise at least one guidance configuration in its tube wall. Preferably it comprises a plurality of guidance configurations, particularly preferably exactly three, distributed along its circumference around the virtual tube axis. If more than one guidance configuration is provided, they are preferably arranged with an equidistant distribution along the circumference. Also preferably, they are embodied identically. The at least one guidance configuration can then be in positive guidance engagement with at least one counterpart guidance configuration of the float valve body, in such a way that the float valve body can move toward and away from the valve opening only along the guidance configuration. If several guidance configurations are provided, each guidance configuration has associated with it a counterpart guidance configuration that interacts with it.

The at least one guidance configuration can be a protrusion projecting radially inward toward the virtual tube axis, the counterpart guidance configuration then preferably being a recess into which the protrusion projects or engages. This would require a protrusion that has a very long component of extent along the virtual tube axis, however, so that the float valve body can be reliably guided during valve operation along its entire motion path as intended. It is therefore simpler if the counterpart guidance configuration comprises a protrusion that projects or engages into a guidance configuration embodied as a recess, for example a groove, in the tube wall. The guidance configuration that is embodied as a recess can be a finite depression in the tube wall without penetrating completely through the tube wall in a thickness direction, or can be a through recess that passes through the tube wall in its thickness direction. One of, several of, or all of the guidance configurations can be the aforementioned passage through the valve housing wall which enables the aforementioned fluid exchange.

The at least one guidance configuration can have, in principle, any profile along the virtual tube axis. For example, the guidance configuration can exhibit, in portions or entirely, a helical profile, such that along its axial extent along the tube axis, it also has a component of extent in a circumferential direction around the tube axis. In order to make possible a motion of the float valve body which is as simple as possible, with the shortest possible motion path between its operating positions, the guidance configuration is preferably constituted in a straight line, and also preferably parallel to the virtual tube axis.

In particular when the guidance configuration is constituted in the tube wall as a passthrough recess, the guidance configuration weakens the valve housing in such a way that it is deformable by a lesser external action than if the guidance configuration were not present. This undesired effect can be mitigated by the fact that the valve housing is embodied at its longitudinal end remote from the tank shell to be continuously encircling. According to this advantageous refinement of the present invention, the guidance configuration thus preferably does not extend as far as that longitudinal end of the valve housing which is located remotely from the tank shell, but instead ends at a distance therefrom along the tube axis. The float valve body can furthermore thereby be retained in lossproof fashion on the valve housing.

In order to make installation of the float valve as simple as possible, it is advantageous if the valve housing is open at its longitudinal end remote from the tank shell. The float valve body can then be introduced into the valve housing through that longitudinal end thereof which is remote from the tank shell. If, as is preferred in principle, the float valve body is a valve body that is sufficiently elastic to be reversibly deformable even without a tool and merely by the muscular strength of an operator, it can then be introduced through the aforesaid longitudinal end into the valve housing even when it comprises one or several protrusions that, in the operationally ready state, constitute counterpart guidance configurations and project into a guidance configuration embodied as a recess on the valve housing wall, and retain the float valve body in lossproof fashion in the valve housing. This also applies to any other positively engaged or physical lossproofing of the float valve body inserted into the valve housing.

The float valve body, constituting an elastic valve body, in particular a valve body deformable merely by muscular strength, can advantageously encompass a foamed material and/or can be embodied as a shell-like hollow body. In the case of a shell-like hollow body, the material thickness should be selected, in consideration of the conformation of the hollow body and of the material used, in such a way that the aforesaid manual deformability is achieved. The foamed material of the deformable valve body is preferably not a hard foam but a flexible foamed material. In addition or alternatively to the valve housing, the float valve body can also comprise a passage in order to enable a fluid exchange between an internal space and external environment of the valve housing.

A preferred conformation of the float valve body embodied as a hollow body is a shell-like bell shape. When the float valve body is embodied as a bell-shaped shell-like hollow body, it has little weight or mass and can easily be deformed at its open longitudinal end in order to be inserted into the valve housing. In the context of a bell-shaped hollow body, and when considering a float valve body inserted into the valve housing, the opening cross section of the bell-shaped hollow body orthogonal to the virtual tube axis or housing axis of the valve housing increases at least in portions in a direction away from the valve opening, and preferably has the largest opening cross section, or at least an opening cross section no smaller than in a region located closer to the valve opening, at its longitudinal end remote from the valve opening. In order to be effectively movable by a rising liquid level in the tank, the bell-shaped float valve body is preferably open toward the internal tank volume in a direction away from the valve opening.

The present invention further relates to a motor vehicle having a liquid tank configured in accordance with the description above.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein:

FIG. 1 is a schematic longitudinal section through a motor-vehicle liquid tank according to the present invention.

### DESCRIPTION OF PREFERRED EMBODIMENTS

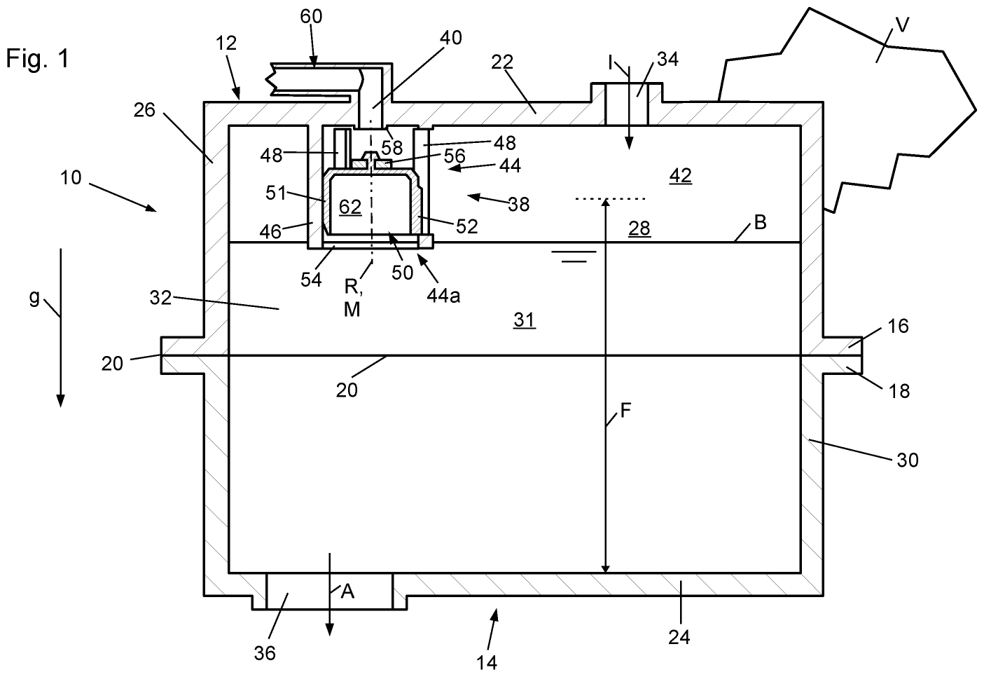

Referring now to the drawings wherein the showings are for the purpose of illustrating preferred and alternative embodiments of the invention only and not for the purpose of limiting the same, in FIG. 1, an embodiment according to the present invention of a motor-vehicle operating-liquid tank is labeled in general with the number 10. In the example depicted, operating-liquid tank 10, arranged on a motor vehicle V, encompasses an upper tank shell 12 and a lower tank shell 14 that are joined to one another to yield tank 10 by means of radially externally proceeding connecting flanges 16 and 18, forming a joining surface 20 in a manner known per se. Connecting flanges 16 and 18 are preferably embodied in one piece respectively with upper tank shell 12 and with lower tank shell 14.

Tank 10 is depicted schematically in longitudinal section in FIG. 1, specifically in a reference state that corresponds to a state in which tank 10 is completely installed in a vehicle standing on a horizontal substrate. The direction of gravity, parallel to the drawing plane of FIG. 1, is labeled g in FIG. 1 for better comprehension.

Tank 10 encompasses a tank lid 22 that is located with a spacing, in direction of gravity g, oppositely from a tank bottom 24. Tank lid 22 and tank bottom 24 are connected to one another via tank side walls 26, 28, and 30. A further tank side wall is located in front of the drawing plane of FIG. 1 and is therefore not depicted.

Tank 10 surrounds a receiving space 32 that comprises an internal tank volume 31 and, in the reference state depicted in FIG. 1, is delimited at the top by tank lid 22, at the bottom by tank bottom 24, and laterally by tank side walls 26, 28, and 30 and by the further tank side wall (not depicted) that is located in front of the drawing plane.

Upper tank shell 12 and lower tank shell 14 are each constituted in one piece, for example by injection molding.

Tank 10 can be filled to a maximum fill height F, through a filler opening 34 that is preferably embodied in tank lid 22, with an operating liquid B. Operating liquid B can flow for that purpose in filling direction I, through filler opening 34, into receiving space 32.

Operating liquid B stored in receiving space 32 can likewise be withdrawn through a withdrawal opening 36 that is preferably embodied in tank bottom 24 which is located geodetically low. Operating liquid B then flows in withdrawal direction A out of tank 10 through withdrawal opening 36. A withdrawal module (not depicted in FIG. 1), which contains functional elements such as a delivery pump, a fill level sensor, a heating system, and the like, can be arranged for that purpose in withdrawal opening 36. The withdrawal module can then comprise a tapping opening to which a liquid conduit that leads to an injection apparatus can be connected, in order to inject liquid withdrawn from tank 10 (in this case e.g. aqueous urea solution or fuel) into an exhaust gas flow for selective catalytic reduction or into a combustion chamber of a combustion engine of motor vehicle V that carries tank 10.

Tank 10 furthermore comprises a float valve 38 that, depending on the fill level of operating liquid B in receiving space 32, opens up a valve opening 40 to allow gas to flow through out of gas space 42 above operating liquid B, or closes off valve opening 40.

Float valve 38 is thus part of an automatic shutoff system of an automatic tank filling system of tank 10. Specifically, when valve opening 40 is closed in terms of a flow of gas through it out of gas space 42, the pressure in internal tank volume 31 rapidly rises as filling continues, and can thereby trigger an automatic shutoff system in a nozzle. Overfilling of tank 10 can thereby be avoided.

Float valve 38 encompasses a tubular (in the example depicted, circularly cylindrically tubular) valve housing 44 that advantageously is embodied in one piece with upper tank shell 12. Valve 44 protrudes along a virtual tube axis R from tank lid 22 exclusively to one side, namely into internal tank volume 31.

The space enclosed by valve housing 42 toward virtual tube axis R does not change, in terms of either size or shape, along the tube axis in a direction away from tank lid 22, except for three guidance configurations 38 (only two of which are shown because of the location of the section plane in FIG. 1) that penetrate through tube wall 46 radially with respect to tube axis R.

A float valve body 50 is introduced into valve housing 44 from the open longitudinal end 44a remote from tank lid 22, along virtual tube axis R, and snap-locked therein.

Float valve body 50, which is bell-shaped in the example depicted, is open toward internal tank volume 31 and has, on its outer surface facing radially outward with respect to tube axis R, the same number of protrusions 52 as valve housing 44 has guidance configurations 48 in tube wall 46.

In the operationally ready state, each protrusion 52 engages into a guidance configuration 48 and thereby secures float valve body 50 on the one hand to prevent rotation around virtual tube axis R and on the other hand to prevent float valve body 50 from falling out of (i.e. being lost from) valve housing 44. Valve housing 44 thus guides float valve body 50, with guidance configurations 48, along a motion path M coincident with tube axis R.

Guidance configurations 48, which pass completely through tube wall 46 of valve housing 44 in a radial direction, do not extend over the entire axial length of valve housing 44 along virtual tube axis R, but instead end at an axial distance, with respect to virtual tube axis R, before longitudinal end 44a that is remote from tank lid 42. As a consequence, a portion of valve housing 44 which is remote from upper tank shell 12, in particular from tank lid 22, and which preferably contains longitudinal end 44a, is embodied uninterruptedly encirclingly in a circumferential direction around virtual tube axis R.

As a result of the bell-shaped configuration of float valve body 50, the latter can be deformed easily and with little energy expenditure so that it can be introduced through opening 54 at longitudinal end 44a, remote from tank lid 22, of valve housing 44; and because of its material-related and geometric elasticity it returns to its undeformed position shown in FIG. 1 after passing through opening 54. In this position, protrusions 52 engage behind those longitudinal ends of guidance configurations 48 which are remote from tank lid 22, and thereby positively secure float valve body 50 in valve housing 44.

In the embodiment depicted, valve housing 44 is embodied in one piece with the tank shell and in one piece overall. A buoyancy body 51 of float valve body 50 is likewise embodied in one piece. It carries, on its side that faces toward valve opening 40 during operation, a valve seal 56 that comes into abutment against a valve seat 58 when operating liquid B rises and moves float valve body 50 toward valve opening 40. Valve seat 58 is a protrusion proceeding annularly around valve opening 44. Valve seat 56 is made of a flexible material, so that it can abut in sealingly deformed fashion against valve seat 58 solely as a result of the buoyancy forces acting during operation on float valve body 50.

Adjacent to valve opening 40 on the outer side of tank 10 is an attachment fitting 60 that is also embodied in one piece with the tank shell (in this case, upper tank shell 12). A hose or other fluid conduit can be attached to attachment fitting 60 so that gas escaping through valve opening 40 can be discharged in controlled fashion.

In an alternative embodiment, cavity 62 of the bell-shaped float valve body 50 can be filled with a foamed material. The entire float valve body 50 can be constituted by foamed material. All that is critical is that float valve body 50 have a lower density, with respect to the space occupied by it (including a gas space constituted in cavity 62), than operating liquid B, so that sufficient buoyancy forces can act on float valve body 50 as operating liquid B rises in tank 10.

Float valve body 50 is shown in FIG. 1 in its operating position, in which valve opening 40 is open to allow gas to flow through out of internal tank volume 31, in particular out of gas space 42. Float valve body 50 is preloaded into this position by gravity. In the absence of buoyancy forces, float valve body 50 is displaced by gravity into the position shown in FIG. 1.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-11. (canceled)

12. A liquid tank, in particular for a motor vehicle, encompassing: a tank shell surrounding an internal tank volume; and at least one tank opening for filling the tank as intended with an associated liquid that is to be stored and/or for removing an associated stored liquid as intended from the tank, the tank further comprising a float valve that, depending on its operating position, opens or closes for a flow of fluid a valve opening that passes through the tank shell and is different from the at least one tank opening,
wherein a valve housing, which guides a float valve in its motion between its closed position in which it closes off the valve opening and its open position in which it enables a flow of associated fluid through the valve opening, is embodied in one piece with the tank shell.

13. The liquid tank according to claim 12, wherein the tank shell comprises a one-piece lower tank shell comprising a tank bottom and a lower, during operation of the tank as intended, portion of tank side walls, and a one-piece upper tank shell comprising a tank lid and an upper, during tank operation as intended, portion of tank side walls, the valve housing being constituted in one piece with the upper tank shell.

14. The liquid tank according to claim 12, wherein the valve housing projects protrudingly from a tank shell portion into the internal tank volume.

15. The liquid tank according to claim 12, wherein the valve housing is configured tubularly and surrounds the float valve body regardless of the latter's operating position.

16. The liquid tank according to claim 15, wherein the tubular valve housing extending along a virtual tube axis comprises in its tube wall a guidance configuration that is in positive guidance engagement with a counterpart guidance configuration of the float valve body in such a way that the float valve body can move toward and away from the valve opening only along the guidance configuration.

17. The liquid tank according to claim 16, wherein the guidance configuration comprises a recess that is radial with respect to the virtual tube axis that notionally passes centrally through tubular valve housing; and the counterpart guidance configuration comprises a protrusion projecting into the recess.

18. The liquid tank according to claim 17, wherein the valve housing is embodied at its longitudinal end remote from the tank shell to be continuously encircling.

19. The liquid tank according to claim 16, wherein the valve housing is embodied at its longitudinal end remote from the tank shell to be continuously encircling.

20. The liquid tank according to claim 12, wherein the valve housing is open at its longitudinal end remote from the tank shell.

21. The liquid tank according to claim 12, wherein at least one of the float valve body encompasses a foamed material and the float valve body is embodied as a shell-like hollow body.

22. The liquid tank according to claim 21, wherein the float valve body is embodied as a bell-shaped, shell-like hollow body that is open toward the internal tank volume in a direction away from the valve opening.

23. A motor vehicle having a liquid tank according to claim 12.
